(19) United States
(12) Patent Application Publication
(10) Pub. No.: US 2014/0255770 A1
(43) Pub. Date: Sep. 11, 2014

(54) Carbon-Sulfur Composite Cathode Passivation and Method for Making Same

(71) Applicants: Jong-Jan Lee, Camas, WA (US); Sean Andrew Vail, Vancouver, WA (US)

(72) Inventors: Jong-Jan Lee, Camas, WA (US); Sean Andrew Vail, Vancouver, WA (US)

(21) Appl. No.: 13/793,559

(22) Filed: Mar. 11, 2013

(51) Int. Cl. H01M 4/36; H01M 4/1393; H01M 4/04

(52) U.S. Cl. CPC H01M 4/366; H01M 4/0404; H01M 4/1393
USPC 429/188; 429/211; 427/122

(57) ABSTRACT

A method is provided for forming a carbon-sulfur (C—S) battery cathode. The method forms a C—S nanocomposite material overlying metal current collector. A dielectric is formed overlying the C—S material that is permeable to lithium (Li) ions and electrolyte, but impermeable to polysulfides. Typically, the C—S nanocomposite material is porous and the dielectric forms a uniform coating of dielectric inside C—S nanocomposite pores. The dielectric includes a metal (M) oxide with an oxy bridge formation (M-O-M). The metal (M) may, for example, be Mg, Al, Si, Ti, Zn, In, Sn, Mn, Ni, or Cu. A C—S battery cathode, and a battery with a C—S are also provided.

### BACKGROUND OF THE INVENTION

1. Field of the Invention

This invention generally relates to batteries and, more particularly, to a sulfur-carbon battery cathode with passivation permeable to lithium ions and electrolyte, but impermeable of polysulfides.

2. Description of the Related Art

A lithium-sulfur (Li—S) battery has a theoretical capacity of ˜1675 milliamp hours per gram (mAh/g), and a specific energy of ˜2600 watt hours per kilogram (Wh/kg). The capacity and specific energy are about 10× and 5×, respectively, higher than conventional Li-ion batteries. However, there are two technical challenges preventing the commercialization of Li—S battery: (1) the sulfur is insulator, and (2) Li—S polysulfides (Li₂S₈, Li₂S₆, Li₂S₄) are soluble in the electrolyte. The later effect results in a loss of sulfur in the cathode and capacity degradation with cycling.

To overcome the insulative nature of sulfur, micron-size sulfur and carbon powders are mixed together to form the cathode. The carbon forms a conducting network, and the sulfur particles are in immediate contact with the carbon network. In one approach, mesoporous carbon and sulfur composite are formed. The mesoporous carbon has a pore size of 1 to 50 nanometers (nm), and the sulfur is stuffed inside the pores. In this case, the distance between the sulfur and carbon is less than 25 nm, and the electrode resistance is much less than an electrode structure that simply mixes carbon and sulfur particles of a larger size.

Polysulfide dissolving in the electrolyte results in a loss of sulfur cathode capacity. In addition, the deposition of lithium sulfide in the anode also leads to an increase of internal cell resistance. This phenomenon is well known in Li—S battery systems and it is called the shuttling effect. During the charging cycle, Li in the cathode is reduced, with the reaction sequence being: Li₂S→Li₂S₂→Li₂S₄→Li₂S₆→Li₂S₈→S. Li₂S and Li₂S₂ are solids, but Li₂S₄, Li₂S₆, and Li₂S₂ can dissolve in a liquid electrolyte. Once polysulfides (Li₂S₄, Li₂S₆, and Li₂S₈) dissolve in electrolyte, they can diffuse to and react with the Li anode. The reactant then diffuses back to cathode (e.g., 2Li₂S₆+2Li→3Li₂S₄) or precipitates at the anode (e.g., Li₂S₄+2Li→2Li₂S₂). Until completing the shuttling effect (consuming all polysulfide in the electrolyte), the charge voltage stays at ˜2.5 volts (V).

To reduce the polysulfide shuttling effect, one approach is to add nanoparticle absorbents to the cathode. Some examples of absorbents include Al₂O₃, SiO₂, MgCuO, and SiO₂. These nanoparticles absorb the polysulfide in cathode, limiting the diffusion of polysulfide to anode. In another approach using a carbon-sulfur nanocomposite structure, the sulfur is stuffed inside nm-size pores and the polysulfides are confined inside the pores because of capillary force.

FIG. 1 is a partial cross-sectional view of a carbon-sulfur (C—S) cathode with a dielectric coating (prior art). In yet another approach, thin dielectrics, e.g., SiO₂, Al₂O₃, are coated on the sulfur particles, or even on the carbon-sulfur nanocomposite particles. The coating layer encapsulates the polysulfides. Although it has been demonstrated that a dielectric coating over a carbon-sulfur cathode improves cycling stability, the thin insulator layer is formed prior to the cathode formation. It covers the sulfur particles or the C—S nanocomposite particles. The coating degrades the electrical connection from current collector to the nanoreactor chamber (C—S composite, where the redox reaction occurs inside the mesoporous pores). Electrons are conducted from Al current collector 100, to carbon black 102, through the insulator (dielectric) coating 104, and to the reaction front (the mesoporous channel in the C—S nanocomposite 106 where S is stored). Electrons moving in and out of the chemical reaction have to drift through the thin insulator 104. Depending upon the particle size and cathode thickness, some electrons have to pass through more than hundred layers of insulator. This insulation significantly increases the cathode resistance and degrades the battery performance.

It would be advantageous carbon-sulfur cathode resistance could be reduced by forming a thin dielectric layer on the cathode that was permeable to Li ions and electrolyte, but encapsulated polysulfide inside the nanometer size pores of the cathode.

### SUMMARY OF THE INVENTION

Disclosed herein is a carbon-sulfur (C—S) battery with a dielectric coating permeable to electrolyte and lithium ions. The cathode process sequence is: C—S nanocomposite formation, cathode slurry preparation, cathode formation, and thin insulator formation. The cathode electrode is fabricated prior to the dielectric coating. The electron path to the nanoreactor chamber (in the C/S composite) is not blocked by the dielectric layer.

Accordingly, a method is provided for forming a C—S battery cathode. The method forms a C—S nanocomposite material overlying a metal current collector. A dielectric is formed overlying the C—S material that is permeable to lithium (Li) ions and electrolyte, but impermeable to polysulfides. Typically, the C—S nanocomposite material is porous and the dielectric forms a uniform coating of dielectric inside C—S nanocomposite, pores. The dielectric includes a metal (M) oxide with an oxy bridge formation (M-O-M). The metal (M) may, for example, be Mg, Al, Si, Zn, In, Sn, Mn, Ni, or Cu.

The dielectric may be formed using a liquid solution deposition process. For example, a metal alkoxide precursor solution is prepared. The C—S nanocomposite material is wetted with metal alkoxide precursor solution and then dipped in water. In response to the water, the metal alkoxide is hydrolyzed, and a metal alkoxide dielectric condenses on the C—S composite material.

Additional details of the above-described method, a C—S battery cathode, and a battery with a C—S are provided below.

### BRIEF DESCRIPTION OF THE DRAWINGS

FIG. 1 is a partial cross-sectional view of a carbon-sulfur (C—S) cathode with a dielectric coating (prior art).

FIG. 2 is a partial cross-sectional view of a C—S battery cathode in detail.

FIG. 3 is a partial cross-sectional view of a battery with a C—S cathode,

FIG. 4 is a flowchart illustrating a method for forming a C—S battery cathode.

### DETAILED DESCRIPTION

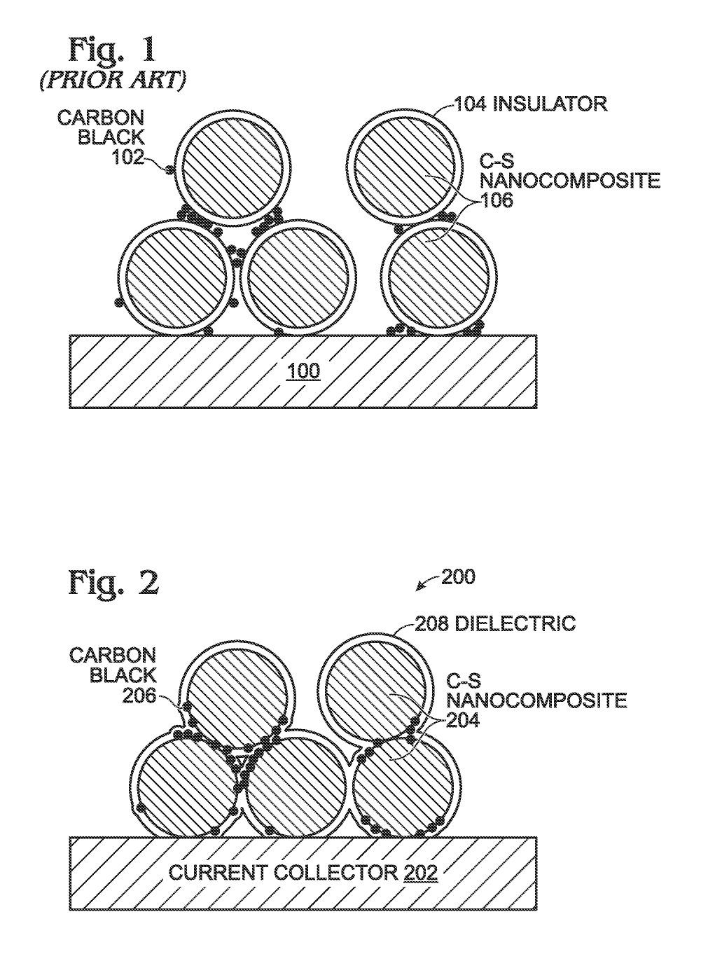

FIG. 2 is a partial cross-sectional view of a C—S battery cathode in detail. The cathode 200 comprises a metal current collector 202. Typically, the metal may be aluminum, but other materials may also be used. A C—S nanocomposite material 204 overlies the current collector 202. As is well understood in the art, the carbon has a high surface area with a matrix of pores. The pores may form channels or passages that are incompletely filled with sulfur particles. For simplicity, the C—S nanocomposite material 204 is shown as a circular particle with a rounded shape. Although C—S nanocomposite particles are depicted as having a uniform size and rounded shape, it should be understood that the actual particles are not limited to any particular shape or size. In one aspect, the shape may be jagged or sharp, with a size in the range of 10 nanometers (nm) to several micrometers (um). The carbon in the C—S composite is not only used to bind the sulfur, but also acts to conduct electrons. Even so, it is common to add carbon black to the C—S nanocomposite material to increase electron conduction. To signify the electrical conductivity characteristics of the carbon black, the carbon black particles 206 are depicted as adhering to the outside of the C—S nanocomposite particle structures. The C—S nanocomposite material 204 may be made with a mesoporous carbon (MPC) [e.g. CMK-3] or highly porous carbon (HPC), for example. A number synthesis processes are known in the art using other carbon family members. The synthesis processes also vary in the size of particles used.

A dielectric 208 overlies the C—S nanocomposite material permeable to lithium ions and electrolyte, but impermeable to polysulfides. As noted above, the C—S nanocomposite material 204 is porous. Therefore, even though the dielectric is shown as a layer overlying the C—S nanocomposite, it should be understood that the dielectric may form a uniform coating inside C—S nanocomposite, pores. The dielectric 208 is a metal (M) oxide with an oxy bridge formation (M-O-M). For example, the metal (M) may be Mg, Al, Si, Ti, Zn, In, Sn, Mn, Ni, or Cu.

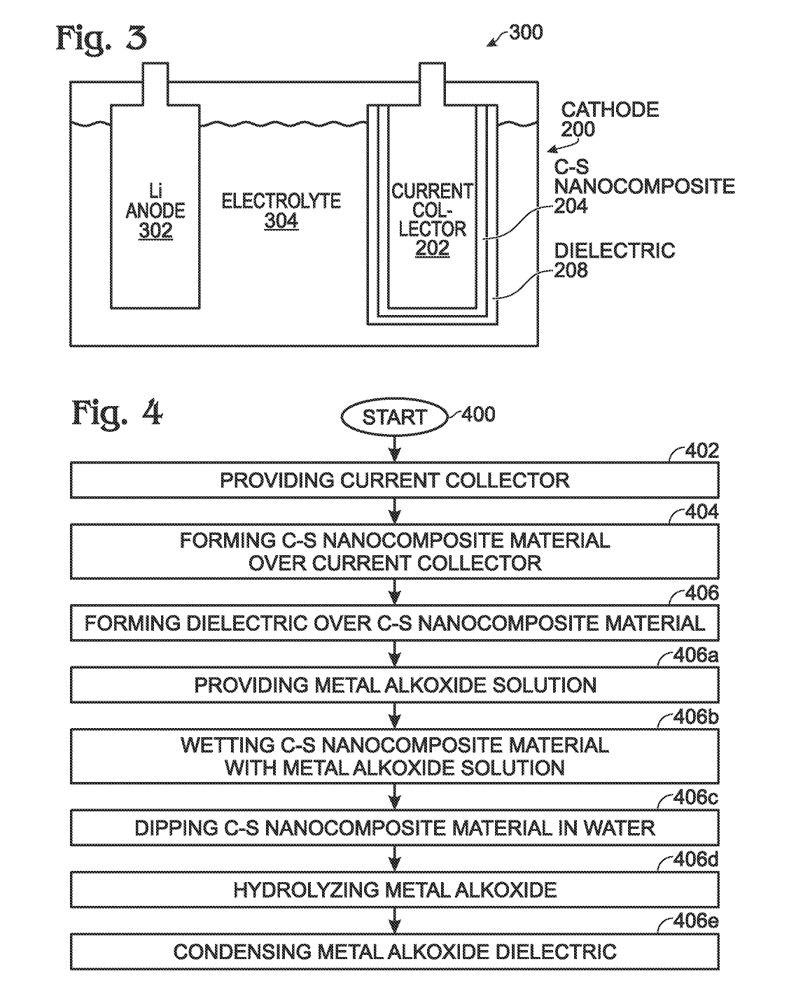

FIG. 3 is a partial cross-sectional view of a battery with a C—S cathode. The battery 300 comprises a lithium (Li) anode 302 and an electrolyte 304 including lithium salt. As shown in FIG. 2, the cathode 200 comprises a metal current collector 202, a C—S nanocomposite material 204 overlying the current collector, and a dielectric 208 overlying the C—S nanocomposite material. The dielectric 208 is permeable to lithium ions and electrolyte, but impermeable to polysulfides. The Li ions are typically in the electrolyte and/or in the polysulfide (LiSx). Details of the cathode have been presented above and are not repeated here in the interest of brevity.

The general process flow for the fabrication of the battery is as follows: C—S composite formation, cathode slurry formation, cathode printing, passivation layer deposition, and battery formation. All the process steps, except the passivation layer deposition, are conventional battery processes, and since they are well understood in the art, no details are presented herein.

### Passivation Layer Deposition

The thin dielectric layer can be deposited by two techniques, vapor phase atomic layer deposition (ALD) or a liquid solution method. The former process requires high vacuum and expensive equipment, so is less suitable for battery applications. The latter process may use a low-cost dip coating process, as described herein. First, a metal alkoxide solution is prepared for use as a precursor. Then, the porous cathode is dipped in the metal alkoxide solution for a period of time (e.g. 30 seconds). Since the electrode is very porous, the solution wets the cathode electrode uniformly. However, no deposition occurs at this time. After taking the cathode electrode out of the metal alkoxide solution and dipping into water, the metal alkoxide undergoes hydrolysis and condensation processes (Equations, 1 and 2) and eventually an M-O-M compound is condensed and deposited uniformly inside the porous cathode. The condensation process in Equation 2 shows an oxo bridge (—O—) formation. The processes continue, so that a -M-O-M-O-M- type linkage occurs. The thickness of the metal oxide layer depends on the precursor concentration. A thicker layer can be obtained with multiple layer depositions.

Hydrolysis: M(OR)ₙ+H₂O→HO-M-(OR)ₙ₋₁+ROH (1)

Condensation: HO-M-(OR)ₙ₋₁+HO-M-(OR)ₙ₋₁→(OR)ₙ₋₁-M-O-M-(OR)ₙ₋₁+H₂O (2)

R represents a proton or other ligand. If R is an alkyl, then OR is an alkoxy group and ROH is an alcohol.

After deposition, the film can be air dried, dried in vacuum, or heated to ˜100° C. in a vacuum. After drying, the deposited film is in an amorphous phase, and it is not necessary to crystallize the metal-oxide film. The film is permeable to an electrolyte, porous enough for ion diffusion (Li⁺), but dense enough to block larger size polysulfide diffusion.

FIG. 4 is a flowchart illustrating a method for forming a C—S battery cathode. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 400.

Step 402 provides a metal current collector. Step 404 forms a C—S nanocomposite material overlying the current collector. As noted above, the C—S nanocomposite material may be formed using a number of conventional means that are well known in the art. Step 406 forms a dielectric overlying the C—S material that is permeable to Li ions and electrolyte, but impermeable to polysulfides. In one aspect, Step 404 forms a porous C—S nanocomposite material, and Step 406 forms a uniform coating of dielectric inside C—S nanocomposite pores. The dielectric is a metal (M) oxide with an oxy bridge formation (M-O-M), where M may be Mg, Al, Si, Ti, Zn, In, Sn. Mn, Ni, or Cu.

In one aspect, forming the dielectric in Step 406 includes using a liquid solution deposition process with the following substeps.

Step 406a prepares a metal alkoxide precursor solution. Step 406b wets the C—S nanocomposite material with metal alkoxide precursor solution. Step 406c dips the C—S nanocomposite material in water. In response to the water, Step 406d hydrolyzes the metal alkoxide. Step 406e condenses a metal alkoxide dielectric on the C—S composite material.

Hydrolyzing the metal alkoxide in Step 406d may include performing the following chemical reaction:

M(OR)ₙ+H₂O→HO-M-(OR)ₙ₋₁+ROH;

where O is oxygen;

where R is a proton or a ligand; and,

where H is hydrogen.

Condensing the metal alkoxide dielectric on the C—S composite material in Step 406e may include performing the following chemical reaction:

HO-M-(OR)ₙ₋₁+HO-M-(OR)ₙ₋₁→(OR)ₙ₋₁-M-O-M-(OR)ₙ₋₁+H₂O.

A C—S battery cathode, a battery with a C—S cathode, and a C—S cathode fabrication process have been provided. Examples of particular materials and process steps have been presented to illustrate the invention. However, the invention is not limited to merely these examples. Other variations and embodiments of the invention will occur to those skilled in the art.

We claim:

1. A carbon-sulfur (C—S) battery cathode comprising:
a metal current collector;
a C—S nanocomposite material overlying the current collector; and,
a dielectric overlying the C—S nanocomposite material permeable to lithium ions and electrolyte, but impermeable to polysulfides.

2. The C—S battery cathode of claim 1 wherein the dielectric is a metal (M) oxide with an oxy bridge formation (M-O-M).

3. The C—S battery cathode of claim 2 wherein the metal is selected from a group consisting of Mg, Al, Si, Ti, Zn, in, Sn, Mn, Ni, and Cu.

4. The C—S battery cathode of claim 1 wherein the C—S nanocomposite material is porous; and,
wherein the dielectric forms a uniform coating inside C—S nanocomposite pores.

5. A method for forming a carbon-sulfur (C—S) battery cathode, the method comprising:
providing a metal current collector
forming a C—S nanocomposite material overlying the current collector; and,
forming a dielectric overlying the C—S material that is permeable to lithium (Li) ions and electrolyte, but impermeable to polysulfides.

6. The method of claim 5 wherein forming the dielectric includes forming a metal (M) oxide with an oxy bridge formation (M-O-M).

7. The method of claim 6 wherein M is selected from a group consisting of Al, Si, Ti, Zn, In, Sn, Mn, Ni, and Cu.

8. The method of claim 5 wherein forming the C—S nanocomposite material includes forming a porous C—S nanocomposite material; and,
wherein forming the dielectric includes forming a uniform coating of dielectric inside C—S nanocomposite pores.

9. The method of claim 5 wherein forming the dielectric includes forming the dielectric using a liquid solution deposition process.

10. The method of claim 9 wherein using the liquid solution deposition process includes:
preparing a metal alkoxide precursor solution;
wetting the C—S nanocomposite material with metal alkoxide precursor solution;
dipping the C—S nanocomposite material in water;
in response to the water, hydrolyzing the metal alkoxide; and,
condensing a metal alkoxide dielectric on the C—S composite material.

11. The method of claim 10 wherein hydrolyzing the metal alkoxide includes performing the following chemical reaction:
M(OR)ₙ+H₂O→HO-M-(OR)ₙ₋₁+ROH;
where O is oxygen;
where R is selected from a group consisting of a proton and a ligand; and,
where H is hydrogen.

12. The method of claim 10 wherein condensing the metal alkoxide dielectric on the C—S composite material includes performing the following chemical reaction:
HO-M-(OR)ₙ₋₁+HO-M-(OR)ₙ₋₁→(OR)ₙ₋₁-M-O-M-(OR)ₙ₋₁+H₂O.

13. A battery with a carbon-sulfur (C—S) cathode, the battery comprising:
a lithium (Li) anode;
an electrolyte including lithium salt;
a cathode comprising:
a metal current collector;
a C—S nanocomposite material overlying the current collector; and,
a dielectric overlying the C—S nanocomposite material permeable to lithium ions and electrolyte, but impermeable to polysulfides.

14. The battery of claim 13 wherein the dielectric is a metal (M) oxide with an oxy bridge formation (M-O-M).

15. The battery of claim 14 wherein the metal is selected from a group consisting of Al, Si, Ti, Zn, In, Sn, Mn, Ni, and Cu.

16. The battery of claim 13 wherein the C—S nanocomposite material is porous; and,
wherein the dielectric forms a uniform coating inside C—S nanocomposite pores.
